(19) United States
(12) Patent Application Publication
(10) Pub. No.: US 2008/0265670 A1
(43) Pub. Date: Oct. 30, 2008

(54) Converter for Providing Several Output Voltages

(75) Inventor: Frans Pansier, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/572,570

(22) PCT Filed: Jul. 19, 2005
(86) PCT No.: PCT/IB05/52407

§ 371 Date: Jan. 24, 2007

(30) Foreign Application Priority Data
Jul. 26, 2004 (EP) 04103564.3

(51) Int. Cl. H02M 3/335

(52) U.S. Cl. 307/12

(57) ABSTRACT

A device for providing several output voltages in a DC/DC converter, which comprises: a series inductance (14) provided with alternating magnetic energy via a loading circuit (11); a first output circuit comprising a first diode (16) coupled to the inductance, and a first capacitor (17) for providing a first output voltage to a first output load (18); a control circuit (19) for controlling the loading circuit to provide sufficient power to the inductance in order to control the first output voltage; at least one auxiliary output circuit comprising an auxiliary diode (21), a switching element (22) and an auxiliary capacitor (23) for providing an auxiliary output voltage to an auxiliary output load (24), the auxiliary output voltage being lower than the first output voltage; and at least one auxiliary control circuit (25). The switching element is controlled to be “on” before the voltage at an anode of the auxiliary diode is higher than the auxiliary voltage of the auxiliary capacitor, and to be “off” when a sufficient energy has been transferred to the auxiliary output circuit to maintain the auxiliary output voltage at a predetermined auxiliary output voltage.

### FIELD OF THE INVENTION

The present invention relates to a converter for providing several output voltages.

### BACKGROUND OF THE INVENTION

A DC/DC converter is disclosed in U.S. Pat. No. 6,344,979. The converter comprises a square wave generator connected to a LLC Resonant Tank, further connected to a primary side of a transformer. The secondary side of the transformer comprises a rectifying circuit for providing a DC voltage to an output load circuit. The converter runs at variable frequency switching to perform output regulation. However, U.S. Pat. No. 6,344,979 does not disclose several independently controlled output voltages.

A DC/DC converter for providing a plurality of output voltages is known from U.S. Pat. No. 6,552,917, which discloses a multiple output flyback converter, including a transformer with a primary switched circuit and a secondary circuit comprising several parallel connected output circuits. Each output circuit comprises a switch and a fast local feedback loop for performing rapid and precise control of the secondary side voltage, and for compensating for small changes in the load in the order of 1 to 5 percent. However, this DC/DC converter is difficult to control as also appears from the indication that less than 5 percent is controlled by the local feedback loop. Moreover, the switches are switched when the voltage is high, causing large switching losses, which degrades the performance of this converter.

Another multiple output DC to DC converter is disclosed in U.S. Pat. No. 5,949,658. This converter comprises a switching circuit to place an alternating voltage from a DC power source across a transformer. The duty cycle of the switching circuit is controlled. The voltage at the secondary side is rectified by two diodes in a center-tapped configuration to create a full-wave output. This output is used to create a primary output voltage, which is regulated by feedback to the primary side switching circuit. An auxiliary output voltage is created by using a secondary side switch and an auxiliary PWM controller to regulated the auxiliary output. By using a bypass element, such as a diode, the losses may be decreased at the expense of lower controllability. The auxiliary circuit produces the same output voltage as the primary output voltage. The switch is opened a short time period after that the diode has started conducting.

This DC/DC converter reduces the power loss by adding a bypass element but cannot provide output voltages that differ substantially. Moreover, the switch is switched “on” when the voltage is high, resulting in switch losses during the switch time.

In certain applications, in which a conventional DC/DC converter is used, such as the DC/DC converter described in U.S. Pat. No. 6,344,979, it is required to provide one or several outputs at lower voltage levels. For example, a DC/DC converter providing an output voltage of 24 V may be used in an application also requiring an output voltage of 12 V and 5V etc. In DC/DC converters, it is always a premium if the conversion can be performed with high efficiency and low heat dissipation. Moreover, a high controllability of the auxiliary output voltages is desirable, including no load conditions.

### SUMMARY OF THE INVENTION

An object of the present invention is to provide a converter capable of providing, in addition to a first regulated output voltage, at least one further, preferably lower, auxiliary output voltage controlled by a local control circuit. The invention is defined by the independent claims. The dependent claims define advantageous embodiments.

The invention comprises controlling the switching element to be “on” before the voltage at an anode of the auxiliary diode is higher than the auxiliary voltage of the auxiliary capacitor; and switching “off” the switching element when a predetermined time has elapsed that is related to the output voltage of the auxiliary circuit. Hereby, it is achieved that the switch is always “on” when the voltage of the inductor starts to rise. The auxiliary circuit has a lower output voltage and, thus, the current initially passes through the auxiliary diode until the switching element is switched off. Now, the current passes over to the normal output and the current passes through the first diode to charge the first capacitor. If the magnetic energy in the inductor is too low, the first output control circuit increases the magnetic energy to the inductor in the next cycle and vice versa. Thus, the auxiliary output circuit “sneaks” some energy from the first output circuit without the first output circuit knowing that, which means that the first control circuit operates for maintaining sufficient energy to both circuits.

In an embodiment of the invention, the switching element is switched “on” when the voltage of the inductance is negative and the auxiliary diode is reverse biased. In an alternative embodiment, the switching element is switched “on” after the time when the inductance voltage is zero but before the time when the inductance voltage has reached the auxiliary output voltage. In this way, the switch element is switched “on” when the current is zero, which means no switch losses.

In a further embodiment, the auxiliary control circuit comprises a timing capacitor. The timing capacitor is connected to a negative voltage during a negative half period of voltage of the inductor, whereby the switching element is switched on; and the timing capacitor is charged during the positive half period of the voltage of the inductor in order to increase the timing capacitor voltage until a predetermined timing capacitor voltage has been obtained, whereby the switching element is switched off.

There may be arranged several auxiliary circuits for providing several auxiliary output voltages as described further below.

### BRIEF DESCRIPTION OF THE DRAWINGS

Further objects, features and advantages of the invention will appear from the following detailed description of the invention with reference to embodiments thereof and with reference to the appended drawings, in which:

FIG. 1 is a schematic block diagram of an embodiment of a DC converter according to the present invention,

FIG. 2 is a detailed diagram of an embodiment of an auxiliary control circuit included in the DC converter of FIG. 1,

FIGS. 3a-3d are diagrams showing voltages and currents of the embodiment of FIG. 2 during one cycle,

FIG. 4 is a further detailed diagram of the control circuit shown in FIG. 2,

FIG. 5 is a detailed diagram similar to FIG. 4, showing still further details of the invention, and

FIG. 6 is a detailed diagram similar to FIG. 4, showing yet further details of the invention.

### DETAILED DESCRIPTION OF EMBODIMENTS

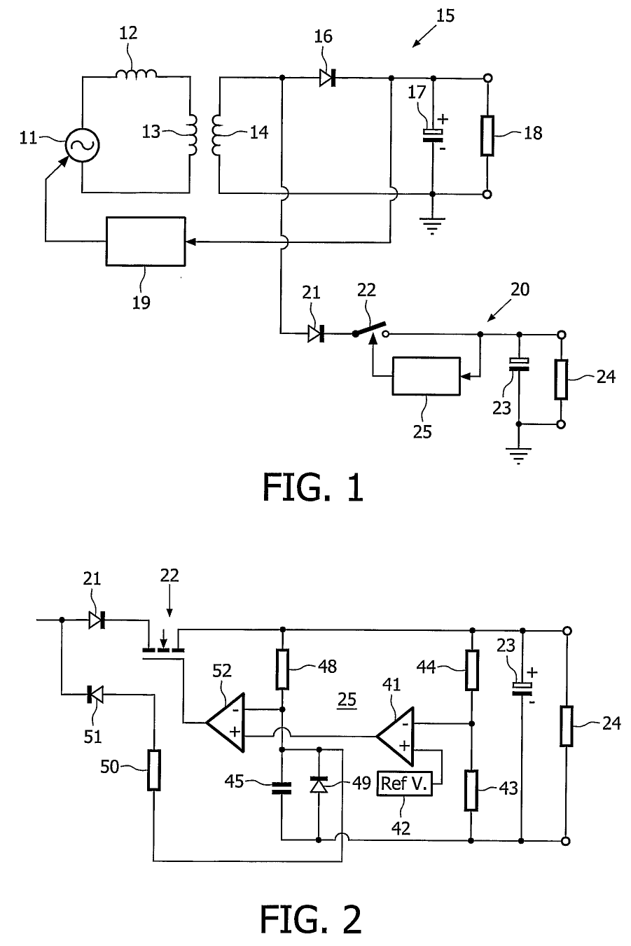

An embodiment of a DC converter according to the present invention is disclosed in FIG. 1. The converter comprises a loading circuit 11 for providing magnetic energy to an inductive element, shown as an inductor 12 connected to a transformer having a primary side 13 and a secondary side 14. The loading circuit may be a LLC Resonant Tank circuit as shown in U.S. Pat. No. 6,344,979 or another circuit that provides energy as described further below.

A main output circuit 15 is connected to the secondary side 14 of the transformer. Circuit 15 comprises a diode 16 or rectifying element connected between the secondary side 14 of the transformer and a capacitor 17. The capacitor provides an output voltage to a main load 18 at a predetermined main voltage, which may be 24 V. The main output circuit 15 is further connected to an output controller circuit 19, which regulates the loading circuit 11 to provide sufficient energy for obtaining the predetermined output voltage. If the output voltage is not reached in a cycle, the loading circuit 11 provides more power the next cycle, and vice versa.

An auxiliary output circuit 20 is also connected to the secondary side 14 of the transformer. The auxiliary output circuit 20 comprises a diode 21, a switch element 22, a capacitor 23, an auxiliary load 24 and a local auxiliary control circuit 25, which controls the switch 22. The auxiliary output circuit is designed to provide an output voltage, for example 12V, which is lower than the main output voltage. This is controlled by the auxiliary control circuit 25 as described below.

Further auxiliary output circuits may be arranged. Thus, a second auxiliary circuit may be arranged having an output voltage, which is lower than the main output voltage. However, it is believed that the controllability of the entire converter becomes more difficult with too many auxiliary output voltages, however, see further below.

An embodiment of the auxiliary output circuit comprising the auxiliary control circuit 25 is disclosed in FIG. 2.

The control circuit 25 comprises an amplifier 41, the positive input of which is connected to a reference voltage 42 of for example 2.5V. The negative input of the amplifier 41 is connected to a resistive voltage division network 43,44 connected over the output capacitor 23. The resistors 43,44 are adjusted so that the voltage of the positive terminal becomes equal to the reference voltage when the output capacitor voltage is at the predetermined nominal output voltage. Amplifier 41 can have a presettable gain. The output voltage of this amplifier is thus a measure of the difference between the actual capacitor output voltage and the nominal voltage. The lower the capacitor output voltage, the higher the output voltage of the amplifier. Thus, the output voltage of the amplifier is inversely related to the capacitor output voltage.

The output of the amplifier 41 is connected to a positive input of a comparator 52. The negative input of the comparator 52 is connected to a timing capacitor 45. The timing capacitor 45 is also connected to the positive output voltage of the capacitor 23 via a charging resistor 48. Thus, resistor 48 charges the capacitor 45.

The timing capacitor is parallel connected with a diode 49, which further is connected via a resistor 50 and a diode 51 to the secondary side of the transformer. When the secondary side 14 of the transformer is negative, diodes 49, 51 and resistor 50 effectively discharges the capacitor 45 and places a negative voltage of one diode-drop over the capacitor (about −0.8V).

The output of the comparator is connected to the gate of the switch transistor 22, which may be a MOSFET transistor. When the output of the comparator 52 is high, the switch transistor is “on” and when the output of the comparator 52 is low, the switch transistor 22 is “off”.

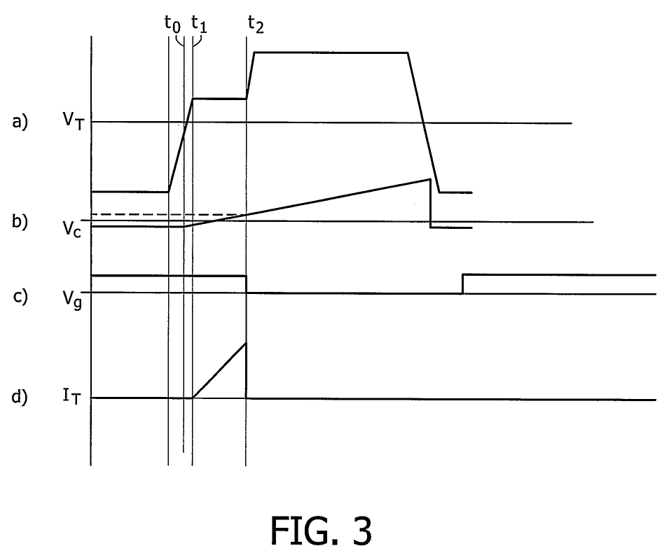

The control circuit works in the following way, with reference to the diagrams shown in FIG. 3. FIG. 3 shows at the upper diagram a) the voltage V_{I} of the secondary side 14 of the transformer. The second diagram b) is the voltage over the charging capacitor 45, V_{C}. The third diagram c) is the output voltage of the comparator 52, which also is the gate voltage V_{G} of the switch transistor 22. The fourth diagram d) is the current I_{T} through the switch transistor.

During the negative half period of the voltage of the secondary winding, the power diodes 16 and 21 are reverse biased and non-conducting. However, diodes 49 and 51 of the control circuit are conducting and discharge any charge prevailing at timing capacitor 45, resulting in a voltage V_{C} of about −0.8V over the timing capacitor. The comparator 52 receives this negative voltage at its negative terminal, which means that the output of the comparator V_{G} is positive, thus turning “on” the switch transistor 22. The positive input of comparator 52 is maintained at a timing voltage determined by the amplifier as explained below.

Thus, switch transistor 22 is already “on” when the voltage of the secondary side 14 of the transformer becomes positive at time t0.

During a first short time period, until time t1, the voltage V_{T} of the secondary side 14 rises, until it reaches the voltage of the auxiliary output circuit having a nominal voltage of 12V. Thus, the diode 31 becomes forward biased and starts conducting current when the voltage of the secondary side 14 becomes 12V. The current starts from zero and increases as shown in the fourth diagram of FIG. 3. The secondary side 14 voltage of the transformer will not increase.

Since the voltage of the secondary side is no longer negative, the diodes 49 and 51 are reverse biased and do not conduct. Thus, timing capacitor 45 is loaded via charging resistor 48 at a slow rate as indicated in the second diagram (V_{C}) of FIG. 3.

When the voltage over timing capacitor reaches the timing voltage present at the positive input of comparator 52, comparator 52 changes from a high output voltage to a low output voltage, thereby turning “off” the switch transistor 22 at time t2.

The timing voltage is controlled by the amplifier 41. If the output voltage of the output capacitor 24 decreases, for example due to an increased load implying that further energy is needed to keep up the voltage, the output voltage of amplifier 41 and, thus, the timing voltage, will increase. This means that the switch transistor 22 will be switched “off” at a later time, whereby the output voltage will be adjusted upwards, and vice versa. The timing voltage is kept relatively constant over a cycle. The gain and bandwidth of amplifier 41 can be adjusted in such a way that gives good performance on load regulation, noise behavior etc.

When the switch transistor 22 is turned “off”, the current from the transformer has to take another way, and then passes via the main diode 16 to the main capacitor 17 and the main load 18. The current strength is maintained when the current is transferred from diode 21 to diode 16, but the rate of increase may change.

The main output controller 19 regulates the energy supply to the transformer so that the energy is sufficient for the main circuit, which is the last circuit.

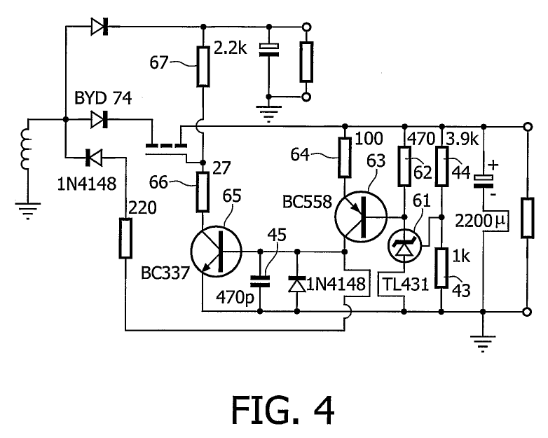

FIG. 4 discloses a more specific embodiment of the control circuit of FIG. 2. The amplifier is embodied as a controlled zener diode 61 of the type TL431, which is an adjustable precision shunt regulator. The resistor network 43,44 is connected to a reference terminal of the zener diode, which has a control voltage of 2.5V. The anode of the zener diode is connected to ground and the cathode is connected to the positive terminal via a resistor 62. The base of a PNP transistor 63 is connected to the junction between the zener diode 61 and the resistor 62. The emitter of the transistor is connected to the positive terminal via a resistor 64 and the collector of the transistor is connected directly to the timing capacitor. This circuit operates as a current source charging the timing capacitor 45 with a current that is determined by the output voltage of the output capacitor. If the voltage of the output capacitor decreases, the voltage at the control terminal of TL431 will also decrease. This results in that the current through resistor 44 also decreases and that the current through transistor 63 decreases. Thus, timing capacitor will be charged by a lower current and, consequently with a lower increase rate.

The comparator is comprised of a NPN transistor 65, the base of which is connected to the timing capacitor 45. The emitter is connected to ground and the collector is connected via a resistor 66 to the gate of the MOSFET switch transistor and further, via a second resistor 67, to the output voltage of the main output circuit. Thus, when the PNP transistor 63 is not conducting, the gate of MOSFET transistor is clamped to a high voltage, whereupon the switch transistor is maintained “on”.

The operation of the circuit of FIG. 4 is similar to the operation of the circuit in FIG. 2. PNP transistor 63 charges the timing capacitor 45 with a current that is dependent of the actual output voltage, but is approximately constant within one switching cycle. When the voltage of timing capacitor reaches about 0.7V, the NPN transistor 65 becomes conducting and effectively grounds the gate electrode of the MOSFET transistor 22, whereupon the switch transistor is switched “off”. The charging current of PNP transistor 63 is sufficient for maintaining a base current to the NPN transistor 65 to maintain it in its conducting condition. Thus, the voltage over the timing capacitor remains at about 0.7V and the switch transistor 22 remains “off”.

During the negative half cycle of the secondary winding voltage, the timing capacitor is discharged to a negative voltage of about −0.8V as previously described. Thus, NPN transistor 65 is switched “off” and the gate of the MOSFET switch transistor is again high, in order to maintain switch transistor “on”.

The NPN transistor may be replaced by another switch element, such as a thyristor or similar means for faster switch-off.

The difference in operation between the circuit of FIG. 2 and the circuit of FIG. 4 is that in FIG. 2, the timing voltage of comparator 52 changes according to the output of error amplifier 41, while in FIG. 4, the comparator level is constant but the rate of rise of the voltage over timing capacitor 45, i.e. the charging current of timing capacitor 45 changes by means of the components 61-64.

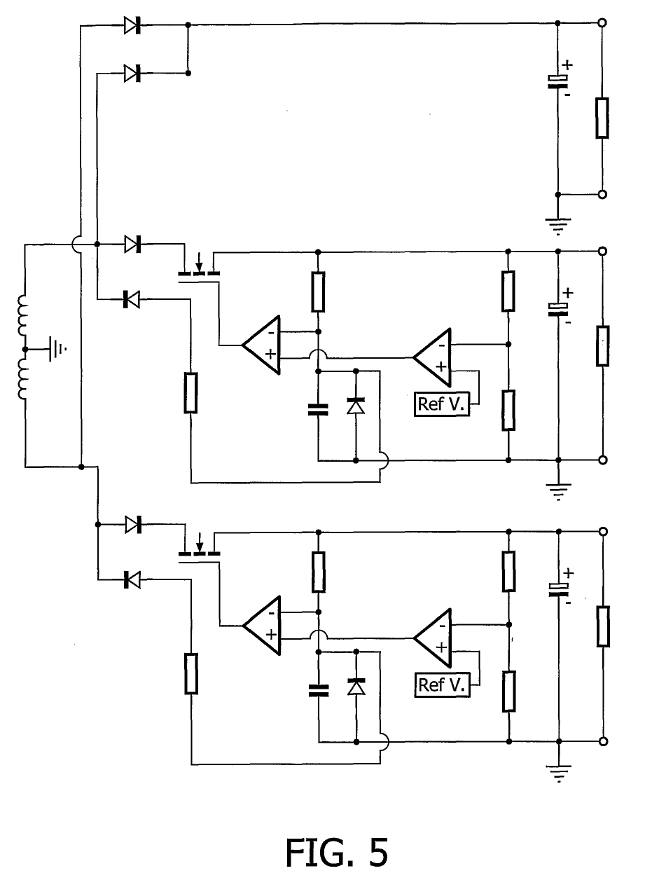

FIG. 5 discloses an alternative design, in which the secondary winding of the transformer comprises a winding with a center tap. One half of the winding is used as described above for producing an auxiliary output voltage 70, while the other half of the winding is used in the other half period for producing another auxiliary output voltage 80. Since the output voltages 70 and 80 are produced in antiphase, that is one when the other is idle, the two outputs can be combined in order to provide an auxiliary output voltage having half the RMS current ripple and double the frequency. This is a considerable advantage, since the output voltage is more easily smoothed, or even may not require smoothing, thus saving components.

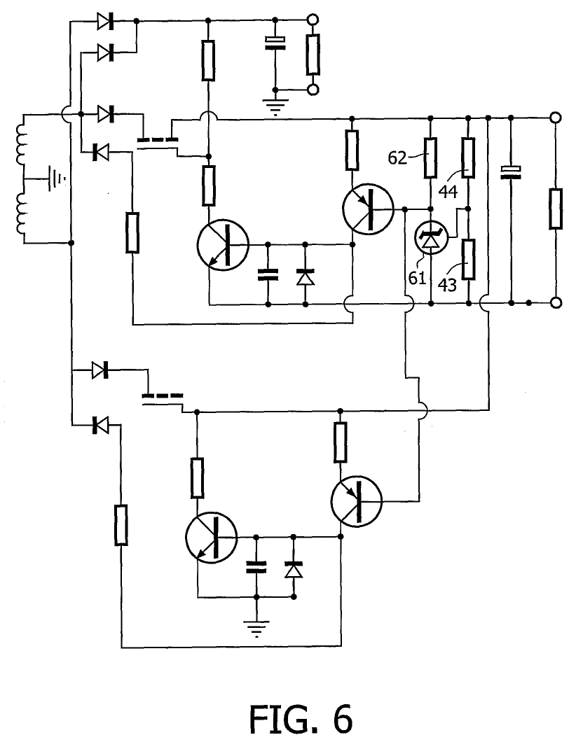

Such a combined circuit is shown in FIG. 6. If the circuit of FIG. 4 is used, the components 43,44, 61 and 62 may be common. Since the switch transistors of each circuit part do not operate simultaneously, it is possible to use one single switch transistor operated by a suitable timing circuit.

The circuit of FIG. 5 may be enlarged by adding a second auxiliary output circuit in each branch, thus providing five different output voltages.

The auxiliary output voltages of FIG. 5 do not need to be different. Thus, two output voltages of 12V may be provided together with a main output voltage of 24V. It is possible to generate output voltages that are higher than the main output voltage, but then the control possibilities may become difficult.

The transformer may be provided with several output windings each connected to one or several separate output circuits. By using a larger number of turns, the output voltage may be higher than the main output voltage.

However, again the controllability becomes more difficult with several output voltages.

The auxiliary output circuit “sneaks” current from the main output circuit. However, the main feedback control does not know about this extra output circuit and operates as if the main circuit draws all current. Thus, the feedback control operates for both circuits. The circuits do affect each other, though only to a limited degree that the regulation will be well within limits in all practical cases.

It is possible to provide a non-load condition of the auxiliary output circuit. If there is no load connected, the output voltage is always at or only slightly above the nominal value. Then, the timing capacitor is charged with a relatively high current through PNP transistor 63 (see FIG. 4). The timing capacitor will be charged to 0.7V during the time span between t0 and t1, and the switch transistor 22 will be switched “off” before it even has started conducting current.

It is not required that the switch transistor is maintained “on” during the entire negative cycle. It is sufficient that it is “on” before the time t1. Thus, a zero crossing detector may be used for switching “on” the switch transistor before time t1. It may also be possible to use the portions of the secondary voltage with high delta V, between time t0 and t1 (and shortly before time t0) for switching “on” the switch transistor 22.

The main idea of the invention is to have all switch transistors “on” before the start of a positive period. Then, the secondary side 14 voltage will automatically charge the auxiliary output circuits in turn depending on the output voltages of each circuit. Finally, the main circuit is charged and the feedback control is activated.

A skilled person realizes that all circuits except in some cases the power components, can be included in an integrated circuit, which may be custom made (ASIC).

If low voltages are being generated, integrated circuits will do well. However, at higher voltages, discrete components may be required.

Other types of switch elements may be used, such as IGBT or bipolar transistors or any other suitable means, which is also true for the diode 21.

Herein above, the invention has been described with reference to specific embodiments. However, the invention is not limited to the various embodiments described but may be amended and combined in different manners as is apparent to a skilled person reading the present specification. The invention is only limited by the appended patent claims.

It is mentioned that the expression “comprising” does not exclude other elements or steps and that “a” or “an” does not exclude a plurality of elements. Moreover, reference signs in the claims shall not be construed as limiting the scope of the claims.

1. A converter for providing several output voltages, the converter comprising:
a series inductance (14) provided with alternating magnetic energy via a loading circuit (11);
a first output circuit comprising a diode (16) coupled to said inductance, and a capacitor (17) for providing a first output voltage to a first output load (18);
a control circuit (19) for controlling the loading circuit to provide sufficient power to said inductance in order to control said first output voltage;
at least one auxiliary output circuit comprising an auxiliary diode (21), a switching element (22), and an auxiliary capacitor (23) for providing an auxiliary output voltage to an auxiliary output load (24), said auxiliary output voltage being lower than said first output voltage; and
at least one auxiliary control circuit (25) for controlling said switching element to be “on” before the voltage at an anode of the auxiliary diode is higher than the auxiliary voltage of the auxiliary capacitor, and to be “off” when a predetermined time has elapsed that is related to the output voltage of said auxiliary circuit.

2. The converter of claim 1, wherein said switching element is switched “on” when the voltage of said inductance is negative and the auxiliary diode is reverse biased.

3. The converter of claim 1, wherein said switching element is switched “on” after the time (t0) when the inductance voltage is zero but before the time (t1) when the inductance voltage has reached the auxiliary output voltage.

4. The converter of claim 1, wherein said auxiliary control circuit comprises a timing capacitor (45), which is connected to a negative voltage during a negative half period of the inductor voltage and is charged during the positive half period of the inductor voltage in order to increase the voltage until a predetermined voltage has been obtained, thereby effectively switching “off” said switching element.

5. The converter of claim 4, wherein said timing capacitor is connected to a current source (49-51) inversely controlled by said auxiliary output voltage.

6. The converter of claim 1, further comprising at least one further auxiliary circuit connected to said inductor in parallel with the first auxiliary circuit.

7. The converter of claim 1, wherein said inductor has a winding with a center tap, and said main output voltage is generated from one part of the inductor winding during one half of a cycle of the inductor voltage and from the other part during the other half of the cycle, to provide a main output voltage with double ripple frequency.

8. The converter of claim 1, wherein said inductor has a winding with a center tap, and said auxiliary voltage is generated from one part of the inductor winding during one half of a cycle of the inductor voltage and from the other part during the other half of the cycle, to provide an auxiliary output voltage with double ripple frequency.

9. The converter of claim 6, wherein some components of the auxiliary circuits are common to the auxiliary circuits.

10. The converter of claim 1, wherein said inductor has a winding with a center tap, and at least one auxiliary voltage is generated from one part of the inductor winding during one half of a cycle of the inductor voltage and at least another auxiliary voltage is generated from the other part during the other half of the cycle.

11. The converter of claim 1, wherein said inductor has a further winding or a tap having a number of turns different from the winding connected to the main circuit and being connected to at least one auxiliary circuit.
